(19) United States
(12) Patent Application Publication
(10) Pub. No.: US 2007/0274556 A1
(43) Pub. Date: Nov. 29, 2007

(54) Speaker Device

(76) Inventors: Toshiyuki Matsumura, Osaka (JP); Shuji Saiki, Nara (JP)

Correspondence Address: WENDEROTH, LIND & PONACK L.L.P., 2033 K. STREET, NW, SUITE 800, WASHINGTON, DC, 20006, US

(21) Appl. No.: 10/594,573

(22) PCT Filed: Apr. 4, 2005
(86) PCT No.: PCT/JP05/06613

§ 371 Date: Sep. 27, 2006

(30) Foreign Application Priority Data
Apr. 5, 2004 (JP) 2004-110779

(51) Int. Cl. H04R 1/28

(52) U.S. Cl. 381/412

(57) ABSTRACT

A speaker device of the present invention roughly comprises a cabinet (1) and a speaker unit (2a). The speaker unit (2a) is attached to an opening portion formed in a front surface of the cabinet (1). The speaker unit (2a) has a back surface frame (3a), a front surface frame (4a), a first magnetic circuit (5a), a second magnetic circuit (6a), an edge (7a), a damper (8a), a diaphragm (9a), a voice coil bobbin (10a), and a voice coil (11a). A non-magnet member (91a) which is a portion of the diaphragm (9a), the first magnetic circuit (5a), and the second magnetic circuit (6a) play a role as a negative stiffness mechanism to suppress an influence of an acoustic stiffness, thereby achieving a small-size speaker device capable of reproducing low-frequency sound.

### TECHNICAL FIELD

The present invention relates to a speaker device and, more particularly, to a speaker device which achieves low-frequency sound reproduction using a small-size cabinet.

### BACKGROUND ART

Conventionally, audio devices are becoming more digitalized, and players for reproducing music sources are becoming smaller and more portable. However, speaker devices for eventually reproducing sounds require large cabinets so as to sufficiently reproduce sounds in a low frequency region included in music sources. Therefore, speaker devices carried in the small-size or portable players have small-volume cabinets, so that an acoustic stiffness exhibited by the cabinet is large, and therefore, it is difficult to achieve low-frequency sound reproduction to a sufficient extent.

Therefore, a speaker device has been disclosed in which a limit of low-frequency sound reproduction which is determined by the volume of a cabinet is improved (see, for example, Patent Document 1). Hereinafter, the speaker device will be described with reference to FIG. 14. Note that FIG. 14 is a cross-sectional view of a structure of the speaker device.

In FIG. 14, the conventional speaker device comprises a cabinet 101 and a speaker unit 102. The speaker unit 102 has a frame 103, an edge 104, a cone-shaped diaphragm 105, a dust cap 106, a voice coil bobbin 107, a damper 108, a voice coil 109, a magnet 110, a center pole 111, a magnetic plate 112, a movable magnet 113, and a fixed magnet 114.

In FIG. 14, the speaker unit 102 is attached to an opening portion on a front surface of the cabinet 101. The magnet 110 is in the shape of a ring. A back surface of the magnet 110 (a surface of the magnet 110 closer to a back side of the cabinet 101) is fixed to a front side of the center pole 111. Aback surface of the magnetic plate 112 is fixed to a front surface of the magnet 110. The voice coil 109 is wound around an outer circumferential surface of an end portion of the voice coil bobbin 107 closer to the back side of the cabinet 101. The voice coil 109 is inserted in a magnetic gap formed between an outer circumferential surface of a convex of the center pole 111 and an inner circumferential surface of the magnetic plate 112. The frame 103 has a sound hole 103h and is fixed to a front surface of the magnetic plate 112. An outer circumference of the damper 108 is fixed to the frame 103 to support the voice coil bobbin 107. The cone-shaped diaphragm 105 is fixed to an end portion closer to the front surface of the voice coil bobbin 107. The edge 104, fixed to the flame 103, supports an outer circumference of the cone-shaped diaphragm 105. The dust cap 106 is fixed to a center portion of the cone-shaped diaphragm 105. The movable magnet 113 is in the shape of a ring, and an inner circumferential surface of the movable magnet 113 is fixed to the outer circumferential surface of the voice coil bobbin 107. The movable magnet 113 is disposed between the cone-shaped diaphragm 105 and the damper 108, in the voice coil bobbin 107. The fixed magnet 114 is in the shape of a ring, and an inner circumferential surface of the fixed magnet 114 faces an outer circumferential surface of the movable magnet 113, forming a gap. The movable magnet 113 and the fixed magnet 114 are magnetized to the same polarity in a thickness direction (vibration direction).

Next, an operation of the conventional speaker device thus configured will be described. When an electrical signal is applied to the voice coil 109, a driving force is generated. The cone-shaped diaphragm 105 fixed to the voice coil bobbin 107 is vibrated by the driving force. Sound is generated by the vibration of the cone-shaped diaphragm 105. The above-described operation is an operation of a typical electrokinetic speaker. The conventional speaker device largely differs from typical speakers in an interaction between the movable magnet 113 fixed to the outer circumferential surface of the voice coil bobbin 107, and the fixed magnet 114 disposed facing the movable magnet 113. The cone-shaped diaphragm 105 is vibrated by the driving force generated by the voice coil 109. In this case, the movable magnet 113 is vibrated together with the voice coil bobbin 107 inside of the fixed magnet 114. The movable magnet 113 and the fixed magnet 114 are magnetized to the same polarity in the vibration direction. Therefore, when the movable magnet 113 is displaced, a magnetic field in which the movable magnet 113 and the fixed magnet 114 repel each other is formed. Therefore, when the movable magnet 113 is displaced from a position where the movable magnet 113 and the fixed magnet 114 are magnetically balanced (hereinafter referred to as a balanced position), a force which allows the movable magnet 113 to escape from the balanced position acts on the movable magnet 113. Specifically, the movable magnet 113 and the fixed magnet 114 act to apply a negative stiffness to a vibration system of the speaker unit 102 at a position deviated from the balanced position. In other words, the movable magnet 113 and the fixed magnet 114 constitute a mechanism for generating a negative stiffness. Hereinafter, the mechanism for generating a negative stiffness is referred to as a negative stiffness generating mechanism.

The negative stiffness acts on the vibration system of the speaker unit 102 so that an acoustic stiffness of the cabinet 101 is reduced. As a result, a minimum resonant frequency of the speaker device decreases. In other words, in the conventional speaker device, even the small-size cabinet can reproduce low-frequency sound as if the speaker unit were mounted in a large-size cabinet.

Patent Document 1: Japanese Patent Laid-Open Publication No. 2000-308174

### DISCLOSURE OF THE INVENTION

### Problems to be Solved by the Invention

However, in the conventional speaker device, the movable magnet 113 which serves as a negative stiffness generating mechanism is provided in the voice coil bobbin 107. As a result, in the conventional speaker device, the weight of the vibration system of the speaker unit 102 increases, so that a level of an output sound pressure of the speaker unit 102 decreases.

In addition, if the size of the movable magnet 113 is reduced to decrease the weight of the vibration system, a magnetic field formed by the movable magnet 113 and the fixed magnet 114 is affected. Specifically, if the size of the movable magnet 113 is reduced, a force which gives the negative stiffness generated by the magnetic field decreases. Therefore, in the conventional speaker device, it is difficult to reduce the weight of the vibration system while keeping the force which gives the negative stiffness. Therefore, in order to increase the output sound pressure level of the speaker unit, it is conventionally necessary to reduce the weight of the vibration system and increase the driving force.

Therefore, an object of the present invention is to provide a small-size speaker device capable of reproducing low-frequency sound while securing an output sound pressure level without increasing a mass of a vibration system. Further, an object of the present invention is to provide a small-size speaker device capable of reproducing low-frequency sound while improving an output sound pressure level by enhancing a driving force, in addition to the above-described object.

### Solution to the Problems

A first aspect of the present invention is directed to a speaker device comprises a housing having an opening portion, a vibration system member for vibrating to generate sound, a support system member connected to the housing and for supporting the vibration system member in a manner which allows the vibration system member to vibrate, a first magnetic circuit provided inside the housing and having a first magnet disposed on a surface thereof facing the opening portion, and a first yoke provided lateral to the first magnet, and a second magnetic circuit having a second magnet disposed inside the housing and facing the first magnet via a gap, and a second yoke provided lateral to the second magnet. A magnetic gap is formed in at least one of an interval between a side surface of the first magnet and the first yoke in the first magnetic circuit and an interval between a side surface of the second magnet and the second yoke in the second magnetic circuit. The vibration system member includes a first voice coil, a first voice coil bobbin provided to dispose the first voice coil in the magnetic gap, and a non-magnet member made of a magnetic material which does not include a magnet, and connected directly or indirectly to the first voice coil bobbin so that the non-magnet member is disposed in the gap between the first magnet and the second magnet.

In a second aspect based on the first aspect, the vibration system member further includes a diaphragm at least a portion of which is composed of the non-magnet member. The first voice coil bobbin is fixed to the diaphragm. The support system member supports the diaphragm in the gap in a manner which allows the diaphragm to vibrate.

In a third aspect based on the first aspect, the second magnetic circuit further includes a magnetic plate fixed to a surface facing the opening portion of the second magnet, the second yoke disposed lateral to the second magnet and the magnetic plate, and forming a magnetic gap between the second magnet and a side surface of the magnetic plate, and forming a second gap between the second magnet and the magnetic plate. The vibration system member further includes a diaphragm disposed, facing a surface facing the opening portion of the housing of the second magnetic circuit. The first voice coil bobbin connects the diaphragm and the non-magnet member via the magnetic gap formed in the second magnetic circuit. The first voice coil is disposed in a magnetic gap formed in the second magnetic circuit.

In a fourth aspect based on the third aspect, the first magnetic circuit further includes a magnetic plate fixed to a surface facing inside of the housing of the first magnet. The first yoke is disposed lateral to the first magnet and the magnetic plate, to form a magnetic gap between the first magnet and a side surface of the magnet plate. The vibration system member further includes a second voice coil, and a second voice coil bobbin fixed to the non-magnet member and for disposing the second voice coil in the magnetic gap formed in the first magnetic circuit.

In a fifth aspect based on the first aspect, the second magnetic circuit further includes a magnetic plate fixed to a surface facing the opening portion of the second magnet. The second yoke is disposed lateral to the second magnet and the magnetic plate, and forms a magnetic gap between the second magnet and a side surface of the magnetic plate. The vibration system member further includes a diaphragm disposed, facing a surface facing the opening portion of the housing of the second magnetic circuit, and a connection member for connecting the diaphragm and the non-magnet member via the magnetic gap formed in the second magnetic circuit. The first voice coil bobbin disposes the first voice coil in the magnetic gap formed in the first magnetic circuit.

In a sixth aspect based on the first aspect, the first and second magnetic circuits have the same structure. The second magnetic circuit and the first magnetic circuit are arranged symmetrically about the non-magnet member.

In a seventh aspect based on the sixth aspect, the vibration system member further includes a second voice coil, and a second voice coil bobbin connected directly or indirectly to the non-magnet member and for disposing the second voice coil in the magnetic gap formed in the first magnetic circuit. The first voice coil bobbin disposes the first voice coil in the magnetic gap formed in the second magnetic circuit.

In an eighth aspect based on the first aspect, the first magnetic circuit further includes a magnetic plate fixed to a surface facing inside of the housing of the first magnet, and a third magnet fixed to a surface facing inside of the housing of the magnetic plate. The first yoke is provided to form a magnetic gap between the first yoke and a side surface of the magnetic plate. The first magnet and the third magnet are magnetized in directions opposite to each other, the directions being vibration directions of the vibration system member.

In a ninth aspect based on the first aspect, the second magnetic circuit further includes a magnetic plate fixed to a surface facing the opening portion of the housing of the second magnet, and a third magnet fixed to a surface facing the opening portion of the housing of the magnetic plate. The second yoke is provided to form a magnetic gap between the second yoke and a side surface of the magnetic plate. The second magnet and the third magnet are magnetized in directions opposite to each other, the directions being vibration directions of the vibration system member.

In a tenth aspect based on the first aspect, the first magnetic circuit further includes a magnetic plate fixed to a surface facing inside of the housing of the first magnet. The first yoke is provided to form a magnetic gap between the first yoke and a side surface of the magnetic plate. The first magnet is magnetized in a vibration direction of the vibration system member.

In an eleventh aspect based on the first aspect, the second magnetic circuit includes a magnetic plate fixed to a surface facing the opening portion of the second magnet. The second yoke is provided to form a magnetic gap between the second yoke and a side surface of the magnetic plate. The second magnet is magnetized in a vibration direction of the vibration system member.

In a twelfth aspect based on the first aspect, the speaker device comprises a plurality of magnetic circuit units each composed of the first and second magnetic circuits. The vibration system member includes the same number of the first voice coils as the number of the magnetic circuit units, the same number of the first voice coil bobbins as the number of the magnetic circuit units, each first voice coil being disposed in the magnetic gap of the corresponding magnetic circuit unit, and a diaphragm fixed to each first voice coil bobbin and at least a portion of which is composed of a non-magnet member.

In a thirteenth aspect based on the first aspect, the speaker device further comprises a position detecting section for detecting a position of the vibration system member, and a control section for controlling a vibration of the vibration system member by applying to the first voice coil a signal obtained by adding a direct current component to an acoustic signal based on the position of the vibration system member detected by the position detecting section so that a center of an amplitude of the non-magnet member is at a balanced position of a magnetic field formed in the gap.

In a fourteenth aspect based on the thirteenth aspect, the position detecting section is a laser displacement gauge.

In a fifteenth aspect based on the first aspect, the speaker device further comprises a frame fixed to the support system member. A speaker unit composed of the vibration system member, the support system member, the first and second magnetic circuits, and the frame, is attached to the opening portion by the frame being fixed to the opening portion.

A sixteenth aspect of the present invention is directed to a car comprising the speaker device according to any of claims 1 to 15, and a car body inside which the speaker device is disposed.

A seventeenth aspect of the present invention is directed to a video device comprising the speaker device according to any of claims 1 to 15, and a device housing inside which the speaker device is disposed.

### EFFECT OF THE INVENTION

According to the first aspect, a force is applied to the non-magnet member included in the vibration member in a direction in which the displacement of the non-magnet member is increased, due to a magnetic field formed in the gap between the first and second magnetic circuits. Therefore, when the non-magnet member is vibrated by the driving force of the voice coil, the amplitude of the non-magnet member is increased by the magnetic field in the gap. Thereby, the acoustic stiffness inside the housing is relaxed, so that even a small-size housing vibrates as if the housing volume were large, thereby making it possible to expand the limit of reproduction of a low-frequency sound band. Also, the force applied to the non-magnet member is generated by the magnetic field formed in the gap between the first and second magnetic circuits. In other words, even when a thickness of the non-magnet member is reduced to some extent, a sufficient force can be generated by the magnetic field formed in the gap between the first and second magnetic circuits. Therefore, a lightweight can be achieved by making the non-magnet member thinner while maintaining the force which relaxes the acoustic stiffness. Thereby, a reduction in the output sound pressure level of the speaker device can be suppressed. Also, by disposing the first voice coil in the gap formed in at least one of the first and second magnetic circuits, the vibration system member is vibrated. In other words, the first and second magnetic circuits can play a role in applying a force in a direction which extends the displacement of the non-magnet member due to the magnetic field formed by the first and second magnetic circuits, and a role in applying a driving force to the first voice coil. According to the first aspect, a single magnet can serve both as a magnet for applying a force to the non-magnet member, and a magnet for applying a driving force to the voice coil, thereby making it possible to reduce the number of parts in the speaker device.

According to the second aspect, since at least a portion of the diaphragm is composed of the non-magnet member, a force for extending the displacement of the non-magnet member can be transferred to the diaphragm with high efficiency.

According to the third aspect, since the first and second magnetic circuits are not disposed on a sound emitting surface of the diaphragm, reproduced sound quality having a satisfactory directivity can be provided.

According to the fourth aspect, since the first and second magnetic circuits are not disposed on a sound emitting surface of the diaphragm, reproduced sound quality having a satisfactory directivity can be provided. Also, since the vibration system member is driven by the first and second voice coils, the output sound pressure level of the speaker device can be improved.

According to the fifth aspect, since the first and second magnetic circuits are not disposed on a sound emitting surface of the diaphragm, reproduced sound quality having a satisfactory directivity can be provided.

According to the sixth aspect, in the gap between the first and second magnetic circuits, a symmetric magnetic field distribution is formed in the vibration direction with respect to the non-magnet member disposed in the gap. Therefore, a distortion due to the asymmetry of a magnetic field distribution can be reduced.

According to the seventh aspect, the first and second voice coils are disposed in the respective magnetic gaps formed in the first and second magnetic circuits, so that a driving force is generated from each voice coil, thereby making it possible to improve the output sound pressure level due to an increase in the driving force.

According to the eighth and ninth aspects, the first and second magnets and the third magnet are magnetized in directions opposite to each other, thereby making it possible to concentrate a larger amount of magnetic flux into the magnetic gap. Thereby, the output sound pressure level of the speaker device can be improved.

According to the tenth and eleventh aspects, the number of magnets included in the magnetic circuit can be reduced. Thereby, it is possible to reduce the size and weight of the speaker device.

According to the twelfth aspect, a plurality of magnetic circuit units are disposed, and the diaphragm is driven by each magnetic circuit unit, thereby making it possible to improve the output sound pressure level of the speaker device. In addition, by disposing the non-magnet members at positions which correspond to nodes of divided resonance of the diaphragm, the divided resonance can be suppressed even when the stiffness of the diaphragm is not increased, thereby making it possible to reduce a thickness of the speaker device. Also, by suppressing the divided resonance, the frequency characteristics of the output sound pressure of the speaker device can be made flat.

According to the thirteenth and fourteenth aspects, the non-magnet member is vibrated about the balanced position of the magnetic fields as a center, irrespective of a change in surrounding environments of the speaker device (e.g., a change in temperature, etc.), thereby making it possible to provide reproduced sound quality with a less distortion.

According to the fifth aspect, it is possible to achieve a speaker device comprising a housing for use in an AV system or the like, and the speaker unit.

According to the sixteenth aspect, it is possible to provide a car in which the speaker device is disposed in a car body.

According to the seventeenth aspect, it is possible to provide a video apparatus in which the speaker device ir disposed.

### BRIEF DESCRIPTION OF THE DRAWINGS

FIG. 1 is a cross-sectional view of a structure of a speaker device according to a first embodiment.

FIG. 2 is a cross-sectional view illustrating a structure of a speaker device which employs a speaker unit 2b composed of a first magnetic circuit 5b.

FIG. 3 is a cross-sectional view of a structure of a speaker device according to a second embodiment.

FIG. 4 is a cross-sectional view illustrating a structure of a speaker device which employs a speaker unit 2d composed of a first magnetic circuit 5d and a second magnetic circuit 6d.

FIG. 5 is a cross-sectional view of a structure of a speaker device according to a third embodiment.

FIG. 6 is a cross-sectional view of a structure of a speaker device according to a fourth embodiment.

FIG. 7 is a perspective view of the speaker device of the fourth embodiment.

FIG. 8 is a cross-sectional view of a structure of a speaker device according to a fifth embodiment.

FIG. 9 is a circuit block diagram of the speaker device of the fifth embodiment.

FIG. 10 is a diagram illustrating an example in which a speaker unit is provided in a car door.

FIG. 11 is a diagram illustrating an exemplary speaker device which is provided inside a car.

FIG. 12 is a diagram illustrating another exemplary speaker device which is provided inside a car.

FIG. 13 is a diagram illustrating an exemplary configuration in which a speaker device is provided in a thin television.

FIG. 14 is a cross-sectional view of a structure of a conventional speaker device.

### DESCRIPTION OF THE REFERENCE CHARACTERS

1, 26, 33 cabinet
2, 23, 28, 34 speaker unit
3 back surface frame
4 front surface frame
5 first magnetic circuit
6 second magnetic circuit
7 edge
8 damper
9 diaphragm
10, 12 voice coil bobbin
11, 13 voice coil
14 dust cap
15, 91 non-magnet member
16 column
17 arm
18 guide
19 laser displacement gauge
20 control circuit
21 window portion
22 door body
24 seat
25, 32 speaker device
27 pedestal
29 punching net
30 thin television main body
31 display
51, 61 yoke
52, 54, 62, 64 magnet
53, 63 magnetic plate
201 drive portion

### BEST MODE FOR CARRYING OUT THE INVENTION

### First Embodiment

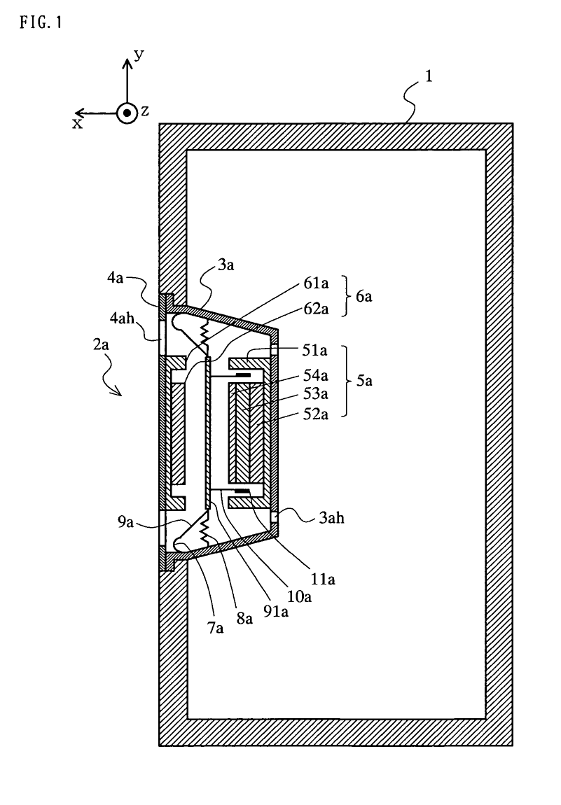

A speaker device according to a first embodiment of the present invention will be described with reference to FIG. 1. FIG. 1 is a cross-sectional view of a structure of the speaker device of the first embodiment. In FIG. 1, the speaker device of the first embodiment roughly comprises a cabinet 1 and a speaker unit 2a. The speaker unit 2a, which is in the shape of, for example, a circle, is attached to an opening portion formed in a front surface (the positive direction of an x axis) of the cabinet 1. The cabinet 1 is a housing which gives an acoustic stiffness to the speaker unit 2a. The speaker unit 2a is composed of a back surface frame 3a, a front surface frame 4a, a first magnetic circuit 5a, a second magnetic circuit 6a, an edge 7a, a damper 8a, a diaphragm 9a, a voice coil bobbin 10a, and a voice coil 11a.

The back surface frame 3a has a shape in which an inner portion thereof is projected in the shape of a convex with respect to an outer circumferential portion thereof. The outer circumference of the back surface frame 3a is attached to the opening portion of the cabinet 1, and the back surface frame 3a is convex toward the inside of the cabinet 1. A sound hole 3ah which is in air communication with the inside of the cabinet 1, is formed in the back surface frame 3a. The front surface frame 4a is fixed to the outer circumferential portion of the back surface frame 3a. A sound hole 4ah for emitting sound forward is formed in the front surface frame 4a. The first magnetic circuit 5 is fixed to a center portion of a bottom surface (the inner portion) of the back surface frame 3a. The second magnetic circuit 6a is fixed to a center portion of a back surface (the negative direction of the x axis) of the front surface frame 4a, and is positioned, facing the first magnetic circuit 5a via a gap. The first and second magnetic circuits 5a and 6a have a cylindrical outer shape. The second magnetic circuit 6a is disposed at a position which allows a center axis thereof coincides with a center axis of the first magnetic circuit 5a. The diaphragm 9a is disposed in the gap between the first magnetic circuit 5a and the second magnetic circuit 6a. At least a portion of the diaphragm 9a is composed of a non-magnet member 91a. The voice coil bobbin 10a is a cylindrical member which is fixed to a side facing the first magnetic circuit 5a of the non-magnet member 91a. The voice coil 11a is wound around an outer circumferential surface of the voice coil bobbin 10a. An outer circumference of the edge 7a is fixed to the outer circumference of the back surface frame 3a. An inner circumference of the edge 7a is fixed to an outer circumference of the diaphragm 9a. Note that the diaphragm 9a and the edge 7a may be integrated together. An outer circumference of the damper 8a is fixed to the back surface frame 3a. An inner circumference of the damper 8a is fixed to the outer circumference of the diaphragm 9a. In the speaker unit 2a, the diaphragm 9a, the voice coil bobbin 10a, and the voice coil 11a are vibration system members which are vibrated by an input electrical signal. The edge 7a and the damper 8a are support system members which support the vibration system members in a manner which allows the non-magnet member 91a to vibrate in the gap between the first magnetic circuit 5a and the second magnetic circuit 6a.

The first magnetic circuit 5a has a yoke 51a, a first magnet 52a, a magnetic plate 53a, and a second magnet 54a. The yoke 51a has a cylindrical side surface, a bottom surface which is formed at one end of the side surface, and an opening at the other end. The bottom surface of the yoke 51a is fixed to a center portion of a bottom surface of the back surface frame 3a. The first magnet 52a is in the shape of a cylinder and is fixed to a center portion on a front surface of the yoke 51a. The magnetic plate 53a is in the shape of a cylinder and is fixed to a front surface of the first magnet 52a. The second magnet 54a is in the shape of a cylinder and is fixed to a front surface of the magnetic plate 53a. A gap is formed between an outer circumferential surface of each of the first magnet 52a, the magnetic plate 53a, and the second magnet 54a, and an inner cylindrical surface of the yoke 51a. In the gap, a magnetic gap is formed between the outer circumferential surface of the magnetic plate 53a and the inner circumferential surface of the yoke 51a. Note that the voice coil 11a is disposed in the magnetic gap, using the voice coil bobbin 10a fixed to the non-magnet member 91a. The first magnet 52a and the second magnet 54a are each magnetized in a vibration direction (an x-axis direction) of the diaphragm 9a. The magnetization directions of the first magnet 52a and the second magnet 54a are opposite to each other.

Here, a magnetic flux of the second magnet 54a passes via the magnetic plate 53a through the magnetic gap. Also, since the second magnet 54a is magnetized in a direction which causes the second magnet 54a to repel the first magnet 52a, the magnetic flux of the first magnet 52a passes through the magnetic gap in a further concentrated manner. In other words, the second magnet 54a increases the magnetic flux density in the magnetic gap to increase a driving force of the voice coil 11a.

The second magnetic circuit 6a has a yoke 61a and a magnet 62a. The yoke 61a has a cylindrical side surface, a bottom surface which is formed at one end of the side surface, and an opening at the other end. The bottom surface of the yoke 61a is fixed to a center portion of a back surface of the front surface frame 4a. The magnet 62a is in the shape of a cylinder and is fixed to a center portion of a back surface of the yoke 61a. Here, a gap is formed between an outer circumferential surface of the magnet 62a and an inner circumferential surface of the yoke 61a, as in the first magnetic circuit 5a. Note that the magnet 62a is magnetized in the vibration direction of the diaphragm 9a. The magnetization direction of the magnet 62a may be the same as or opposite to that of the second magnet 54a.

At least a portion of the diaphragm 9a is composed of the non-magnet member 91a. The non-magnet member 91a is a magnetic material other than magnets. Examples of the non-magnet member 91a include magnetic materials, such as iron, permalloy, and the like, which do not have as strong a coercive force as that of magnets. The non-magnet member 91a may be disposed in a gap between the first and second magnetic circuits. Therefore, for example, an entire surface of the diaphragm 9a may be composed of the non-magnet member 91a. An area obtained by projecting the gap formed between the first and second magnetic circuits perpendicularly onto the diaphragm 9a is in the shape of a ring. A magnetic field in the vicinity of the ring-shaped area can generate a repelling force (described below) most strongly with respect to the non-magnet member 91a. Therefore, the ring-shaped area of the diaphragm 9a is preferably composed of the non-magnet member 91a. Also, for example, a portion of the diaphragm 9a corresponding to the circular shape of the yoke 51a or the yoke 61a may be composed of the non-magnet member 91a. Note that, as a specific exemplary structure of the diaphragm 9a and the non-magnet member 91a, the plate-shaped non-magnet member 91a may be joined onto both or either of the surfaces of the non-magnetic material diaphragm 9a.

Next, an operation of the speaker device of this embodiment will be described. When an electrical signal is applied to the voice coil 11a, a driving force is generated by a current flowing through the voice coil 11a and a magnetic field formed in the magnetic gap. The driving force vibrates the diaphragm 9a to generate sound. This is a basic operation of an electrokinetic speaker.

The diaphragm 9a, at least a portion of which is composed of the non-magnet member 91a, vibrates in the gap between the first magnetic circuit 5a and the second magnetic circuit 6a. The vibration direction of the diaphragm 9a is the front-to-back surface direction (the x-axis direction). In this case, pulling forces in the vibration direction are alternately applied to the non-magnet member 91a by the magnetic field formed by the first and second magnetic circuits, depending on the vibration of the diaphragm 9a. For example, when the diaphragm 9a is displaced closer to the first magnetic circuit 5a, a force is applied to the non-magnet member 91a by the magnetic field formed by the first and second magnetic circuits in a direction which increases the displacement. The pulling forces applied to the non-magnet member 91a by the magnetic field formed by the first and second magnetic circuits are balanced between the first magnetic circuit 5a and the second magnetic circuit 6a. Hereinafter, a position in the gap where the pulling forces are balanced is referred to as a balanced position. The diaphragm 9a vibrates while the non-magnet member 91a receives a repelling force in a direction which causes the non-magnet member 91a to go away from the balanced position by the magnetic filed formed by the first and second magnetic circuits.

On the other hand, the acoustic stiffness of an empty room enclosed by the cabinet 1, the diaphragm 9a, and the edge 7a suppresses the vibration of the diaphragm 9a using the spring force. The spring force increases with a decrease in volume of the empty room. Also, the larger the spring force, the more significantly the vibration of the diaphragm 9a is suppressed. In contrast to this, the repelling force generated by the magnetic field formed by the first and second magnetic circuits, acts in a direction which cancels the spring force received by the acoustic stiffness. In other words, the repelling force acts as a negative stiffness which reduces the acoustic stiffness. Thus, the non-magnet member 91a of the diaphragm 9a, the first magnetic circuit 5a, and the second magnetic circuit 6a play a role as a mechanism for generating a negative stiffness (negative stiffness generating mechanism). Thereby, the suppression by the acoustic stiffness is relaxed, so that the diaphragm 9a becomes easy to vibrate. The diaphragm 9a operates as if the cabinet volume were large, so that the minimum resonant frequency of the speaker unit 2a is reduced. As a result, the limit of low-frequency sound reproduction can be expanded.

As described above, the negative stiffness generating mechanism relaxes the influence of the acoustic stiffness of the empty room enclosed by the cabinet 1, the diaphragm 9a, and the edge 7a. Thereby, the speaker device of this embodiment, even in the case of a small-size cabinet, operates as if the cabinet volume were large, so that the limit of low-frequency sound reproduction can be expanded.

Also, in the negative stiffness generating mechanism, a repelling force is applied to the non-magnet member 91a by the magnetic field formed by the first and second magnetic circuits. Therefore, in the structure, even when a thickness of the non-magnet member 91a is reduced to some extent, a sufficient level of repelling force can be generated with respect to the non-magnet member 91a. Therefore, in this embodiment, the non-magnet member 91a joined with the diaphragm 9a can be made thin, so that the weight of the vibration system can be significantly reduced as compared to a conventional speaker device which employs the movable magnet 113. As a result, in the speaker device of this embodiment, it is possible to suppress a reduction in the output sound pressure level of the speaker unit 2a.

The first magnetic circuit 5a plays a role as an electrokinetic converter, and the negative stiffness generating mechanism shares a portion of the first magnetic circuit 5a. Thereby, the speaker device of this embodiment can suppress the size due to an increase in volume of a magnet, labor cost, and price cost, as compared to when all magnetic circuits constituting a negative stiffness generating mechanism are newly provided.

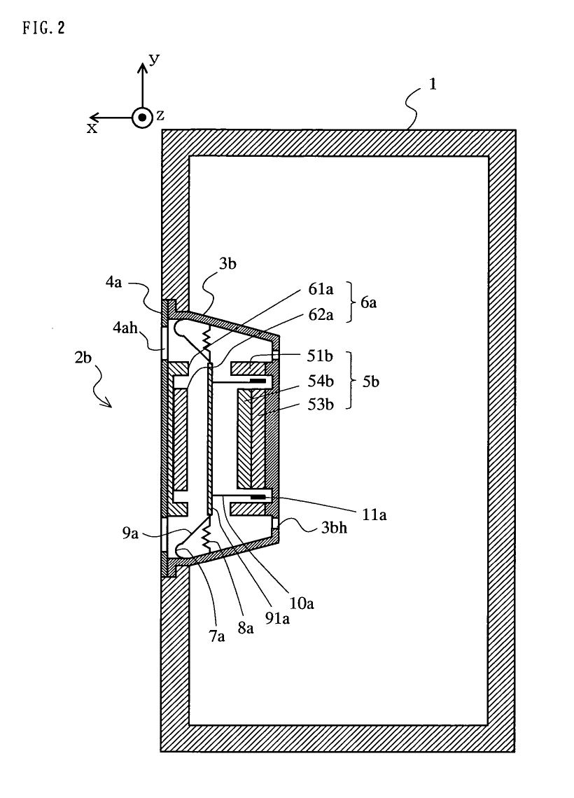

Note that the above-described first magnetic circuit 5a may be a first magnetic circuit 5b of FIG. 2. FIG. 2 is a cross-sectional view illustrating a structure of a speaker device which employs a speaker unit 2b composed of the first magnetic circuit 5b. In FIG. 2, a front surface frame 3b is different from the above-described front surface frame 3a only in a shape of a center portion thereof to which the first magnetic circuit 5b is fixed. The first magnetic circuit 5b is fixed to a center portion of a bottom surface of the back surface frame 3b.

The first magnetic circuit 5b has a yoke 51b, a magnet 54b, and a magnetic plate 53b. The magnetic plate 53b is in the shape of a cylinder, and is fixed to the center portion of the bottom surface of the back surface frame 3b. The magnet 54b is in the shape of a cylinder, and is fixed to a front surface of the magnetic plate 53b. A magnetic gap is formed between an outer circumferential surface of the magnetic plate 53b and an inner circumferential surface of the yoke 51b. Note that the magnet 54b is magnetized in a vibration direction of a diaphragm 9a. The magnet 52b may have a magnetization direction the same as or opposite to that of the magnet 62a. The yoke 51d is in the shape of a ring, and is fixed to the bottom surface of the back surface frame 3b so that the magnetic plate 53b and the magnet 54b are disposed in an inner circumference thereof. In FIG. 2, the first magnetic circuit 5b, the second magnetic circuit 6a, and the non-magnet member 91a play a role as a negative stiffness generating mechanism.

As described above, the above-described first magnetic circuit 5a may be replaced with the first magnetic circuit 5b of FIG. 2. In this case, the speaker unit 2b can have a smaller number of magnets, and therefore, has an advantage in terms of cost.

Note that, in FIG. 1, the positions of the first magnetic circuit 5a and the second magnetic circuit 6a may be switched. In this case, the voice coil bobbin 10a is fixed to the front surface of the non-magnet member 91a, and the voice coil is disposed in the magnetic gap of the first magnetic circuit 5a. Similarly, in FIG. 2, the positions of the first magnetic circuit 5b and the second magnetic circuit 6a may be switched. Although the speaker units 2a and 2b are in the shape of, for example, a circle in the above description, the speaker units 2a and 2b may have other shapes, such as an elliptical shape, a rectangular shape, an elongate shape, or the like. Alternatively, the speaker units 2a and 2b may be in the shape of a racetrack in which only two opposite sides of a rectangle are replaced with semicircles (hereinafter referred to as a track shape). The shapes of the magnets, the yokes, the magnetic plates, and the diaphragms included in the speaker units 2a and 2b may be set as appropriate so as to fit the shapes of the speaker units 2a and 2b. For example, when the speaker unit is in the shape of a rectangle, the diaphragm may be in the shape of a rectangle, and the magnet may be in the shape of a rectangular prism.

### Second Embodiment

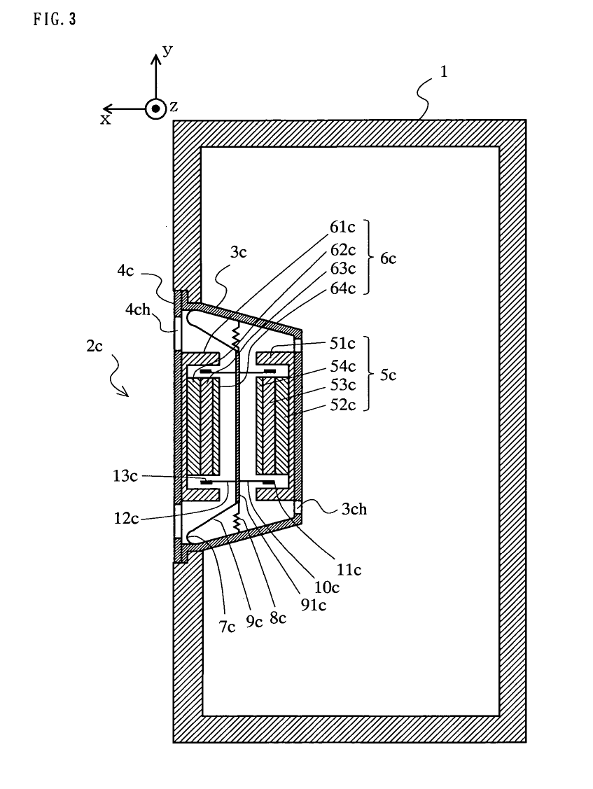

A speaker device according to a second embodiment of the present invention will be described with reference to FIG. 3. FIG. 3 is a cross-sectional view of a structure of the speaker device of the second embodiment. In FIG. 3, the speaker device of the second embodiment roughly comprises a cabinet 1 and a speaker unit 2c. The speaker unit 2c, which is in the shape of, for example, a circle, is attached to an opening portion formed in a front surface (the positive direction of an x axis) of the cabinet 1. The cabinet 1 is a housing which gives an acoustic stiffness to the speaker unit 2c. The speaker unit 2c is different from the speaker unit 2a of the first embodiment in that both the first and second magnetic circuits both form magnetic gaps, and two voice coil bobbins and two voice coils are provided. Hereinafter, a structure of the speaker unit 2c will be described.

The speaker unit 2c is composed of a back surface frame 3c, a front surface frame 4c, a first magnetic circuit 5c, a second magnetic circuit 6c, an edge 7c, a damper 8c, a diaphragm 9c, a first voice coil bobbin 10c, a first voice coil 11c, a second voice coil bobbin 12c, and a second voice coil 13c.

The back surface frame 3c has a shape in which an inner portion thereof is projected in the shape of a convex with respect to an outer circumferential portion thereof. The outer circumference of the back surface frame 3c is attached to the opening portion of the cabinet 1, and the back surface frame 3c is convex toward the inside of the cabinet 1. A sound hole 3ch which is in air communication with the inside of the cabinet 1, is formed in the back surface frame 3c. The front surface frame 4c is fixed to the outer circumferential portion of the back surface frame 3c. A sound hole 4ch for emitting sound forward is formed in the front surface frame 4c. The first magnetic circuit 5c is fixed to a center portion of a bottom surface (the inner portion) of the back surface frame 3c. The second magnetic circuit 6c is fixed to a center portion of a back surface (the negative direction of an x axis) of the front surface frame 4c, and is positioned, facing the first magnetic circuit 5c via a gap. The first and second magnetic circuits 5c and 6c have a cylindrical outer shape. The second magnetic circuit 6c is disposed at a position which allows a center axis thereof coincides with a center axis of the first magnetic circuit 5c. The diaphragm 9c is disposed in the gap between the first magnetic circuit 5c and the second magnetic circuit 6c. At least a portion of the diaphragm 9c is composed of a non-magnet member 91c. The first voice coil bobbin 10c is a cylindrical member which is fixed to a surface facing the first magnetic circuit 5c of the non-magnet member 91c. The first voice coil 11c is wound around an outer circumferential surface of the first voice coil bobbin 10c. The second voice coil bobbin 12c is a cylindrical member which is fixed to a surface facing the second magnetic circuit 6c of the non-magnet member 91c. The second voice coil 13c is wound around an outer circumferential surface of the second voice coil bobbin 12c. An outer circumference of the edge 7c is fixed to an outer circumference of the back surface frame 3c. An inner circumference of the edge 7c is fixed to an outer circumference of the diaphragm 9c. Note that the diaphragm 9c and the edge 7c may be integrated together. An outer circumference of the damper 8c is fixed to the back surface frame 3c. An inner circumference of the damper 8c is fixed to the outer circumference of the diaphragm 9c. In the speaker unit 2c, the diaphragm 9c, the first and second voice coil bobbins, and the first and second voice coils are vibration system members which are vibrated by an input electrical signal. The edge 7c and the damper 8c are support system members which support the vibration system members in a manner which allows the non-magnet member 91c to vibrate in the gap between the first magnetic circuit 5c and the second magnetic circuit 6c.

The first magnetic circuit 5c has a yoke 51c, a first magnet 52c, a magnetic plate 53c, and a second magnet 54c. The yoke 51c has a cylindrical side surface, a bottom surface which is formed at one end of the side surface, and an opening at the other end. A bottom surface of the yoke 51c is fixed to the center portion of the bottom surface of the back surface frame 3c. The first magnet 52c is in the shape of a cylinder and is fixed to a center portion of a front surface of the yoke 51c. The magnetic plate 53c is in the shape of a cylinder and is fixed to a front surface of the first magnet 52c. The second magnet 54c is in the shape of a cylinder and is fixed to a front surface of the magnetic plate 53c. A gap is formed between an outer circumferential surface of each of the first magnet 52c, the magnetic plate 53c, and the second magnet 54c, and an inner cylindrical surface of the yoke 51c. In the gap, a magnetic gap is formed between the outer circumferential surface of the magnetic plate 53c and the inner circumferential surface of the yoke 51c. Note that the first voice coil 11c is disposed in the magnetic gap formed in the first magnetic circuit 5c, using the first voice coil bobbin 10c fixed to the non-magnet member 91c. The first magnet 52c and the second magnet 54c are each magnetized in a vibration direction (an x-axis direction) of the diaphragm 9c. The magnetization directions of the first magnet 52c and the second magnet 54c are opposite to each other.

Here, a magnetic flux of the second magnet 54c passes via the magnetic plate 53c through the magnetic gap. Also, since the second magnet 54c is magnetized in a direction which causes the second magnet 54c to repel the first magnet 52c, the magnetic flux of the first magnet 52c passes through the magnetic gap in a further concentrated manner. In other words, the second magnet 54c plays a role in increasing the magnetic flux density in the magnetic gap to increase a driving force of the first voice coil 11c.

The second magnetic circuit 6c has a yoke 61c, a first magnet 62c, a magnetic plate 63c, and a second magnet 64c. The yoke 61c has a cylindrical side surface, a bottom surface which is formed at one end of the side surface, and an opening at the other end. The bottom surface of the yoke 61c is fixed to a center portion of a back surface of the front surface frame 4c. The first magnet 62c is in the shape of a cylinder and is fixed to a center portion of a back surface of the yoke 51c. The magnetic plate 63c is in the shape of a cylinder and is fixed to a back surface of the first magnet 62c. The second magnet 64c is in the shape of a cylinder and is fixed to a back surface of the magnetic plate 63c. Here, as is similar to the first magnetic circuit 5c, a gap is formed between an outer circumferential surface of each of the first magnet 62c, the magnetic plate 63c and the second magnet 64c, and an inner circumferential surface of the yoke 61c. A magnetic gap is formed in the gap between the outer circumferential surface of the magnetic plate 63c and the yoke 61c. Note that the second voice coil 21 is disposed in the magnetic gap formed in the second magnetic circuit 6c, using the second voice coil bobbin 12c fixed to the non-magnet member 91c. The first magnet 62c and the second magnet 64c are each magnetized in a vibration direction of the diaphragm 9c. The magnetization directions of the first magnet 62c and the second magnet 64c are opposite to each other. Note that the second magnet 64c enhances the driving force of the second voice coil 13c as with the above-described second magnet 54c.

Here, the magnetization directions of the second magnet 54c and the second magnet 64c, and the winding directions of the first and second voice coils, will be described. When the second magnet 54c and the second magnet 64c are caused to have the same magnetization direction, the winding directions of the first and second voice coils are set to be opposite to each other. When the magnetization direction of the second magnet 54c and the second magnet 64c are caused to be opposite to each other, the winding directions of the first and second voice coils are set to be the same. Thereby, when a current is applied to the first and second voice coils, driving forces are obtained in the same direction.

As is similar to the first embodiment above, at least a portion of the diaphragm 9c is composed of the non-magnet member 91c. The non-magnet member 91c is a magnetic material other than magnets. The position of the non-magnet member 91c and the structure of the diaphragm 9c are similar to those of the diaphragm 9a and the non-magnet member 91a of the first embodiment above and will not be described.

Next, an operation of the speaker device of this embodiment will be described. When an electrical signal is applied to the first voice coil 11c and the second voice coil 13c, a current flows through each voice coil and a magnetic field is formed in each magnetic gap, so that a driving force is generated in each voice coil in the same direction. Each driving force vibrates the diaphragm 9c, thereby generating sound.

The diaphragm 9c, at least a portion of which is composed of the non-magnet member 91c, vibrates in the gap between the first magnetic circuit 5c and the second magnetic circuit 6c. The vibration direction of the diaphragm 9c is the front-to-back surface direction (the x-axis direction). In this case, pulling forces in the vibration direction are alternately applied to the non-magnet member 91c by the magnetic field formed by the first and second magnetic circuits, depending on the vibration of the diaphragm 9c. In other words, in this embodiment, the non-magnet member 91c, the first magnetic circuit 5c, and the second magnetic circuit 6c play a role as a negative stiffness generating mechanism. Note that the negative stiffness generating mechanism is similar to that of the first embodiment above and will not be described. By the negative stiffness generating mechanism, the suppression by the acoustic stiffness of the empty room enclosed by the cabinet 1, the diaphragm 9c, and the edge 7c is relaxed, so that the diaphragm 9c becomes easy to vibrate. The diaphragm 9c operates as if the cabinet volume were large, so that the minimum resonant frequency of the speaker unit 2c is reduced. As a result, the limit of low-frequency sound reproduction can be expanded.

As described above, the negative stiffness generating mechanism relaxes the influence of the acoustic stiffness of the empty room enclosed by the cabinet 1, the diaphragm 9c, and the edge 7c. Thereby, the speaker device of this embodiment, even in the case of a small-size cabinet, operates as if the cabinet volume were large, so that the limit of low-frequency sound reproduction can be expanded.

In the speaker unit 2c of this embodiment, a driving force is generated in each of the first and second voice coils, so that the driving force is increased as compared to the first embodiment. As a result, in this embodiment, the output sound pressure level can be further improved.

In the speaker unit 2c of this embodiment, the first and second magnetic circuits are symmetric about the non-magnet member 91c. Thereby, in the gap between the first and second magnetic circuits, a symmetric magnetic field distribution is formed in the vibration direction from the balanced position of the gap. Therefore, a distortion due to the asymmetry of a magnetic field distribution can be reduced.

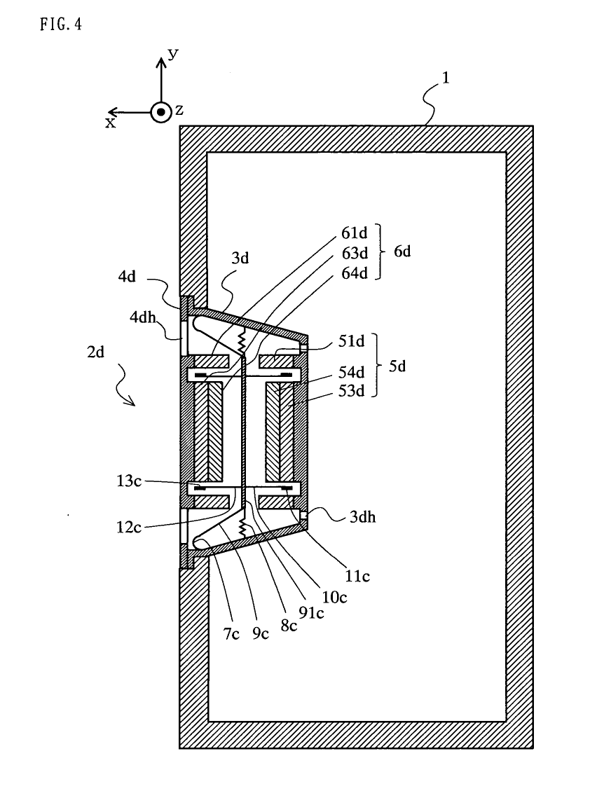

Note that, as in the first embodiment, the above-described first and second magnetic circuits may be a first magnetic circuit 5d and a second magnetic circuit 6d of FIG. 4, respectively. FIG. 4 is a cross-sectional view illustrating a structure of a speaker device which employs a speaker unit 2d composed of the first magnetic circuit 5d and the second magnetic circuit 6d. In FIG. 4, a front surface frame 4d is different from the front surface frame 4a only in a shape of a center portion thereof to which the second magnetic circuit 6d is fixed. A back surface frame 3d is different from the above-described back surface frame 3c only in a shape of a center portion thereof to which the first magnetic circuit 5d is fixed. The first magnetic circuit 5d is fixed to a center portion of a bottom surface of the back surface frame 3d. The second magnetic circuit 6d is fixed to a center portion of a back surface of the front surface frame 4d.

The first magnetic circuit 5d has a yoke 51d, a magnet 54d, and a magnetic plate 53d. The magnetic plate 53d is in the shape of a cylinder, and is fixed to the center portion of the bottom surface of the back surface frame 3d. The magnet 54d is in the shape of a cylinder, and is fixed to a front surface of the magnetic plate 53d. The yoke 51d is in the shape of a ring, and is fixed to the bottom surface of the back surface frame 3d so that the magnetic plate 53d and the magnet 54d are disposed in an inner circumference thereof. A magnetic gap is formed between an outer circumferential surface of the magnetic plate 53d and an inner circumferential surface of the yoke 51d. Note that the magnet 54d is magnetized in a vibration direction of a diaphragm 9c.

The second magnetic circuit 6d has a yoke 61d, a magnet 64d, and a magnetic plate 63d. The magnetic plate 63d is in the shape of a cylinder, and is fixed to a center portion of a back surface of the front surface frame 4d. The magnet 64d is in the shape of a cylinder, and is fixed to a back surface of the magnetic plate 63d. The yoke 61d is in the shape of a ring, and is fixed to the back surface of the front surface frame 4d so that the magnetic plate 63d and the magnet 64d are disposed in an inner circumference thereof. A magnetic gap is formed between an outer circumferential surface of the magnetic plate 63d and an inner circumferential surface of the yoke 61d. Note that the magnet 64d is magnetized in a vibration direction of the diaphragm 9c. In FIG. 4, the first magnetic circuit 5d, the second magnetic circuit 6d, and the non-magnet member 91c play a role as a negative stiffness generating mechanism.

As described above, the first and second magnetic circuits may be the first magnetic circuit 5d and the second magnetic circuit 6d of FIG. 4. In this case, the speaker unit 2d has a smaller number of magnet components, and therefore, has an advantage in terms of cost, as compared to the speaker unit 2c.

Although the speaker units 2c and 2d are in the shape of, for example, a circle in the above description, the speaker units 2c and 2d may have other shapes, such as an elliptical shape, a track shape, a rectangular shape, an elongate shape, or the like. The shapes of the parts (e.g., a magnet, etc.) included in each speaker unit are similar to those of the first embodiment above.

### Third Embodiment

A speaker device according to a third embodiment of the present invention will be described with reference to FIG. 5. FIG. 5 is a cross-sectional view of a structure of the speaker device of the third embodiment. In FIG. 5, the speaker device of the third embodiment roughly comprises a cabinet 1 and a speaker unit 2e. The speaker unit 2e, which is in the shape of, for example, a circle, is attached to an opening portion formed in a front surface (the positive direction of an x axis) of the cabinet 1. The cabinet 1 is a housing which gives an acoustic stiffness to the speaker unit 2e. The speaker unit 2e is different from the speaker unit 2c of the second embodiment in that a second magnetic circuit is supported by a column disposed in a gap between the second magnetic circuit and a first magnetic circuit, so that the front surface frame is no longer required, and an outer appearance thereof is similar to that of conventional speaker units, and that a magnetic material does not form a portion of a diaphragm and is fixed to a voice coil bobbin. Hereinafter, a structure of the speaker unit 2e will be described.

The speaker unit 2e is composed of a back surface frame 3e, a first magnetic circuit 5e, a second magnetic circuit 6e, an edge 7e, a damper 8e, a diaphragm 9e, a first voice coil bobbin 10e, a first voice coil 11e, a second voice coil bobbin 12e, a second voice coil 13e, a non-magnet member 15e, and a column 16e.

The back surface frame 3e has a shape in which an inner portion thereof is projected in the shape of a convex with respect to an outer circumferential portion thereof. The outer circumference of the back surface frame 3e is attached to an opening portion of the cabinet 1, and the back surface frame 3e is convex toward the inside of the cabinet 1. A sound hole 3eh which is in air communication with the inside of the cabinet 1, is formed in the back surface frame 3e. The first magnetic circuit 5e is fixed to a center portion of a bottom surface (the inner portion) of the back surface frame 3e. The second magnetic circuit 6e is positioned, facing the first magnetic circuit 5e via the column 16e. The first and second magnetic circuits 5e and 6e have a cylindrical outer shape. The second magnetic circuit 6e is disposed at a position which allows a center axis thereof coincides with a center axis of the first magnetic circuit 5e. The non-magnet member 15e is a ring-shaped plate and is a magnetic member which does not include a magnet. The non-magnet member 15e is disposed in a gap between the first magnetic circuit 5e and the second magnetic circuit 6e. Note that the column 16e is positioned at an open hole of an inner circumferential portion of the non-magnet member 15e. The first voice coil bobbin 10e is a cylindrical member which is fixed to a surface facing the first magnetic circuit 5e of the non-magnet member 15e. The first voice coil 11e is wound around an outer circumferential surface of the first voice coil bobbin 10e. The second voice coil bobbin 12e is a cylindrical member, one end of which is fixed to a surface facing the second magnetic circuit 6e of the non-magnet member 15e. The second voice coil 13e is wound around an outer circumferential surface at the other end of the second voice coil bobbin 12e. An inner circumference of the diaphragm 9e is fixed to the other end of the second voice coil bobbin 12e. An outer circumference of the edge 7e is fixed to the vicinity of an outer circumference of the back surface frame 3e. An inner circumference of the edge 7e is fixed to an outer circumference of the diaphragm 9e. Note that the diaphragm 9e and the edge 7e may be integrated together. An outer circumference of the damper 8e is fixed to the back surface frame 3e. An inner circumference of the damper 8e is fixed to the outer circumference of the diaphragm 9e. In the speaker unit 2e, the diaphragm 9e, the first and second voice coil bobbins, the non-magnet member 15e, and the first and second voice coils are vibration system members which are vibrated by an input electrical signal. The edge 7e and the damper 8e are support system members which support the vibration system members in a manner which allows the non-magnet member 15e to vibrate in the gap between the first magnetic circuit 5e and the second magnetic circuit 6e. A dust cap 14e is a portion of the diaphragm 9e.

The first magnetic circuit 5e has a yoke 51e, a magnet 54e, and a magnetic plate 53e. The magnetic plate 53e is in the shape of a cylinder and is fixed to a center portion of a bottom surface of the back surface frame 3e. The magnet 54e is in the shape of a cylinder and is fixed to a front surface of the magnetic plate 53e. The yoke 51e is in the shape of a ring, and is fixed to a front surface of the back surface frame 3e so that the magnetic plate 53e and the magnet 54e are disposed in an inner circumference thereof. A gap is formed between an outer circumferential surface of each of the magnetic plate 53e and the magnet 54e, and an inner cylindrical surface of the yoke 51e. A magnetic gap is formed between the outer circumferential surface of the magnetic plate 53e and the inner circumferential surface of the yoke 51e. Note that the magnet 54e is magnetized in a vibration direction (an x-axis direction) of the diaphragm 9e and the non-magnet member 15e. The first voice coil 11e is disposed in the magnetic gap formed in the first magnetic circuit 5e, by the first voice coil bobbin 10e fixed to the non-magnet member 15e.

The second magnetic circuit 6e has a yoke 61e, a magnetic plate 63e, and a magnet 64e. The yoke 61e is a ring-shaped yoke whose an outer circumferential surface is fixed to the back surface frame 3e. The magnet 64e is in the shape of a cylinder, and is fixed to the column 16e fixed to the magnet 54e. Specifically, the magnet 64e is positioned, facing the magnet 54e by means of the column 16e. The magnetic plate 63e is in the shape of a cylinder, and fixed to a front surface of the magnet 64e. A gap through which the second voice coil bobbin 12e can penetrate is formed between an outer circumferential surface of each of the magnetic plate 63e and the magnet 64e, and an inner circumferential surface of the yoke 61e. In the gap, a magnetic gap is formed between the outer circumferential surface of the magnetic plate 63e and the inner circumferential surface of the yoke 61e. Note that the magnet 64e is magnetized in a vibration direction of the diaphragm 9e and the non-magnet member 15e. The second voice coil 13e is disposed in the magnetic gap formed in the second magnetic circuit 6e, by the second voice coil bobbin 12e fixed to the non-magnet member 15e.

Here, the magnetization directions of the magnet 54e and the magnet 64e, and the winding directions of the first and second voice coils, will be described. When the magnet 54e and the magnet 64e are caused to have the same magnetization direction, the winding directions of the first and second voice coils are set to be opposite to each other. When the magnetization direction of the magnet 54e and the magnet 64e are caused to be opposite to each other, the winding directions of the first and second voice coils are set to be the same. Thereby, when a current is applied to the first and second voice coils, driving forces are obtained in the same direction.

The non-magnet member 15e is a ring-shaped plate and is a magnetic material other than magnets. The non-magnet member 15e may be disposed in a gap between the first and second magnetic circuits. Therefore, for example, the non-magnet member 15e may have a shape corresponding to the circular shape of the yoke 51e or the yoke 61e. An area obtained by projecting the gap formed between the first and second magnetic circuits perpendicularly onto the non-magnet member 15e is in the shape of a ring. A magnetic field in the vicinity of the ring-shaped area can generate a repelling force most strongly with respect to the non-magnet member 15e. Therefore, more preferably, the non-magnet member 15e corresponds to the ring-shaped area.

Next, an operation of the speaker device of this embodiment will be described. When an electrical signal is applied to the first voice coil 11e and the second voice coil 13e, a current flows through each voice coil and a magnetic field is formed in each magnetic gap, so that a driving force is generated in each voice coil in the same direction. Each driving force vibrates the diaphragm 9e, thereby generating sound.

The non-magnet member 15e, to which the first and second voice coil bobbins are fixed, vibrates in the gap between the first magnetic circuit 5e and the second magnetic circuit 6e. The vibration direction of the non-magnet member 15e is the front-to-back surface direction (the x-axis direction). In this case, pulling forces in the vibration direction are alternately applied to the non-magnet member 15e by the magnetic field formed by the first and second magnetic circuits, depending on the vibration of the non-magnet member 15e. In other words, in this embodiment, the non-magnet member 15e, the first magnetic circuit 5e, and the second magnetic circuit 6e play a role as a negative stiffness generating mechanism. Note that the negative stiffness generating mechanism is similar to that of the first embodiment above and will not be described. By the negative stiffness generating mechanism, the suppression by the acoustic stiffness of the empty room enclosed by the cabinet 1, the diaphragm 9e, and the edge 7e is relaxed, so that non-magnet member 15e and the diaphragm 9e become easy to vibrate. Specifically, the diaphragm 9e operates as if the cabinet volume were large, so that the minimum resonant frequency of the speaker unit 2e is reduced. As a result, the limit of low-frequency sound reproduction can be expanded.

As described above, the negative stiffness generating mechanism relaxes the influence of the acoustic stiffness of the empty room enclosed by the cabinet 1, the diaphragm 9e, and the edge 7e. Thereby, the speaker device of this embodiment, even in the case of a small-size cabinet, operates as if the cabinet volume were large, so that the limit of low-frequency sound reproduction can be expanded.

In this embodiment, there is not a frame in front of the diaphragm 9e, so that sound quality is not inhibited, as compared to the second embodiment above.

In the speaker unit 2e of this embodiment, the first and second magnetic circuits are symmetric about the non-magnet member 15e as in the second embodiment above. Thereby, in the gap between the first and second magnetic circuits, a symmetric magnetic field distribution is formed in the vibration direction from the balanced position of the gap. Therefore, a distortion due to the asymmetry of a magnetic field distribution can be reduced.

Note that, in this embodiment, the magnetic plate 53e, the first voice coil bobbin 10e, and the voice coil 11e may be eliminated. Also, the magnetic plate 63e and the second voice coil 13e may be eliminated. In this case, the second voice coil bobbin 12e plays a role as a connection member for connecting the non-magnet member 15e and the diaphragm 14e. In this case, as compared to the speaker unit 2e of this embodiment, the number of magnet components can be reduced, resulting in an advantage in terms of cost.

Although the speaker unit 2e is in the shape of, for example, a circle in this embodiment, the speaker unit 2e may have other shapes, such as an elliptical shape, a track shape, a rectangular shape, an elongate shape, or the like, as in the first embodiment above. The shapes of the parts (e.g., a magnet, etc.) included in each speaker unit are similar to those of the first embodiment above.

### Fourth Embodiment

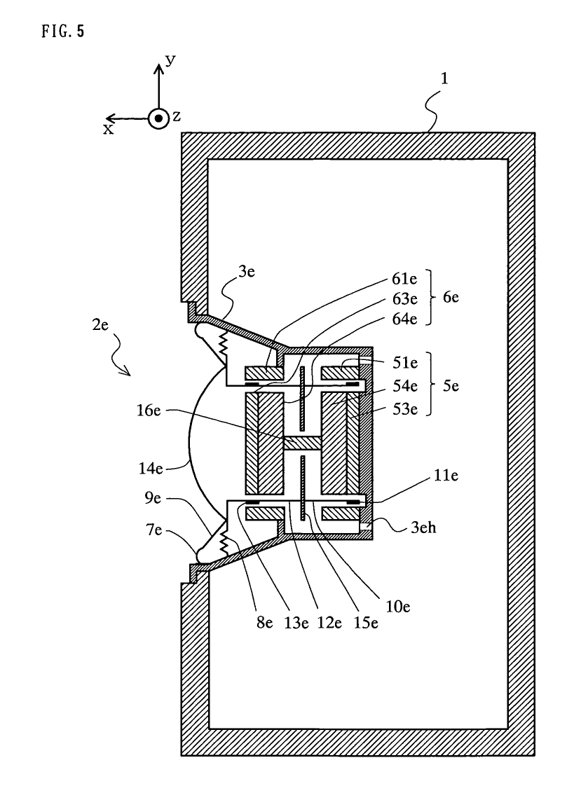

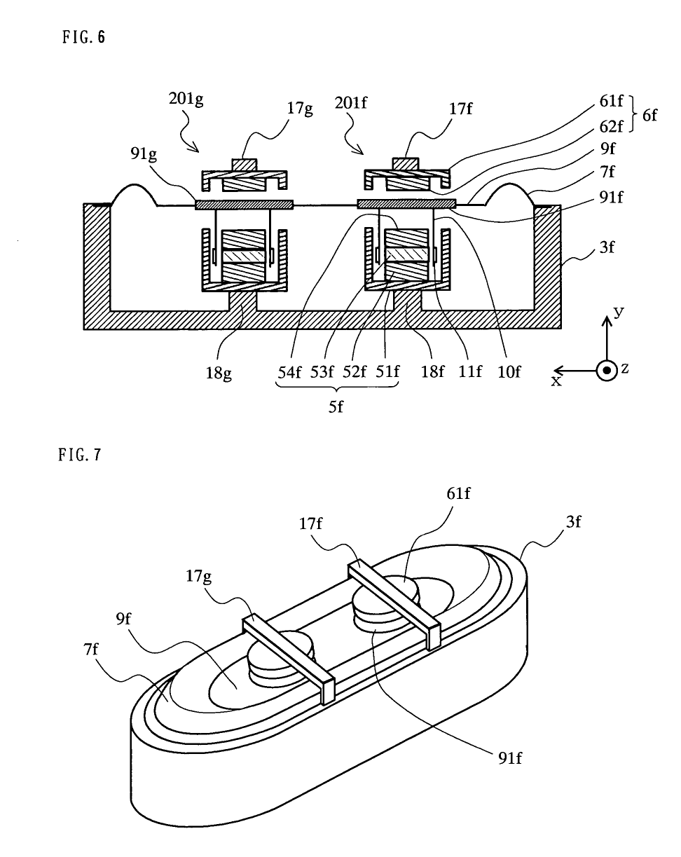

A speaker device according to a fourth embodiment of the present invention will be described with reference to FIGS. 6 and 7. FIG. 6 is a cross-sectional view of a structure of the speaker device of the fourth embodiment. FIG. 7 is a perspective view of the speaker device of the fourth embodiment.

In FIG. 6, the speaker device of the fourth embodiment roughly comprises a back surface frame 3f, a drive portion 201f, a drive portion 201g, an edge 7f, a diaphragm 9f, an arm 17f, and an arm 17g. The back surface frame 3f is a housing in which an opening portion is formed at an upper surface thereof (the positive direction of a y axis). The drive portion 201f is fixed to a convex guide 18f formed inside the back surface frame 3f. The drive portion 201g is fixed to another guide 18g. Note that the drive portion 201g has a configuration similar to that of the drive portion 201f and will not be described in detail. The diaphragm 9f is used in common by the drive portions 201f and 201g, and has a track shape. At least a portion of the diaphragm 9f is composed of a non-magnet member 91f and a non-magnet member 91g. An outer circumference of the edge 7f is fixed to the opening portion formed at the upper surface of the back surface frame 3f. An inner circumference of the edge 7f is fixed to an outer circumference of the diaphragm 9f. Note that the diaphragm 9f and the edge 7f may be integrated together. The back surface frame 3f may have a track shape as viewed from the top as illustrated in FIG. 7, for example. The back surface frame 3f is a housing which gives an acoustic stiffness to the drive portions 201f and 201g. This embodiment is different from the above-described first to third embodiments in that a frame serves as a housing which gives an acoustic stiffness instead of a cabinet, and that a plurality of magnetic circuits (drive portions) to drive a diaphragm at a number of points. Hereinafter, a structure of the drive portion 201f will be mainly described.

The drive portion 201f has a first magnetic circuit 5f, a second magnetic circuit 6f, a voice coil bobbin 10f, and a voice coil 11f. The first magnetic circuit 5f is fixed to the convex guide 18f formed inside the back surface frame 3f. The arm 17f is in the shape of an arch, and is fixed to the back surface frame 3f. The second magnetic circuit 6f is fixed to the arm 17f, and is positioned, facing the first magnetic circuit 5f. A center axis on a surface facing the first magnetic circuit 5f of the second magnetic circuit 6f coincides with a center axis of the first magnetic circuit 5f. The voice coil bobbin 10f is a cylindrical member which is fixed to a surface facing the first magnetic circuit 5f of the non-magnet member 91f. The voice coil 11f is wound around an outer circumferential surface of the voice coil bobbin 10f. Here, the diaphragm 9f is disposed in a gap between the first and second magnetic circuits of each of the drive portions 201f and 201g. In this embodiment, the diaphragm 9f, the non-magnet members 91f and 91g, the voice coil bobbin 10f and the voice coil 11f, and the voice coil bobbin 10f and the voice coil 11f of the drive portion 201g are vibration system members which are vibrated by an input electrical signal. The edge 7f is a support system member which supports the vibration system members in a manner which allows the non-magnet member 91f and the non-magnet member 91g to vibrate in the gap between the first magnetic circuit and the second magnetic circuit.

The first magnetic circuit 5f has a yoke 51f, a first magnet 52f, a magnetic plate 53f, and a second magnet 54f. The yoke 51f has a cylindrical side surface, a bottom surface which is formed at one end of the side surface, and an opening at the other end. The yoke 51f is fixed to the convex guide 18f formed inside the back surface frame 3f. The first magnet 52f is in the shape of a cylinder, and is fixed to a center portion of an upper surface of the yoke 51f. The magnetic plate 53f is in the shape of a cylinder, and is fixed to an upper surface of the first magnet 52f. The second magnet 54f is in the shape of a cylinder, and is fixed to an upper surface of the magnetic plate 53f. A gap is formed between an outer circumferential surface of each of the first magnet 52f, the magnetic plate 53f, and the second magnet 54f, and an inner circumferential surface of the yoke 51f. In the gap, a magnetic gap is formed between the outer circumferential surface of the magnetic plate 53f and the inner circumferential surface of the yoke 51f. Note that the voice coil 11f is disposed in the magnetic gap by the voice coil bobbin 10f fixed to the non-magnet member 91f. The first magnet 52f and the second magnet 54f are each magnetized in a vibration direction of the diaphragm 9f. The magnetization directions of the first magnet 52f and the second magnet 54f are opposite to each other.

Here, a magnetic flux of the second magnet 54f passes via the magnetic plate 53f through the magnetic gap. Also, since the second magnet 54f is magnetized in a direction which causes the second magnet 54f to repel the first magnet 52f, the magnetic flux of the first magnet 52f passes through the magnetic gap in a further concentrated manner. In other words, the second magnet 54f increases the magnetic flux density in the magnetic gap to increase a driving force of the first voice coil 11f.

The second magnetic circuit 6f has a yoke 61f and a magnet 62f. The yoke 61f has a circular bottom surface and a cylindrical side surface. An opening portion is formed at a side opposite to the circular bottom surface. The yoke 61f is fixed to the arm 17f. The magnet 62f is in the shape of a cylinder, and is fixed to a center portion of the bottom surface of the yoke 61f. Here, as in the first magnetic circuit 5f, a gap is formed between an outer circumferential surface of the magnet 62f and an inner circumferential surface of the yoke 61f. Note that the magnet 62f is magnetized in a vibration direction (a y-axis direction) of the diaphragm 9f. The magnetization direction the magnet 62f may be the same as or opposite to that of the second magnet 54f.

The diaphragm 9f is used in common by the drive portions 201f and 201g, and has a track shape. At least a portion of the diaphragm 9f is composed of the non-magnet member 91f and the non-magnet member 91g. In FIG. 6, the non-magnet member 91f and 91g are, for example, circular plates joined with the diaphragm 9f so that the non-magnet members 91f and 91g are disposed in a gap between the first and second magnetic circuits of the respective drive portions 201f and 201g. Note that an area obtained by projecting the gap formed between the first and second magnetic circuits perpendicularly onto the diaphragm 9f is in the shape of a ring. A magnetic field in the vicinity of the ring-shaped area can generate a repelling force most strongly with respect to the non-magnet member 91f. Therefore, more preferably, the non-magnet member 91f corresponds to the ring-shaped area. Also, for example, the non-magnet member 91f may correspond to the circular shape of the yoke 51f or the yoke 61f. The non-magnet member 91g is similar to the non-magnet member 91f. Also, for example, an entire surface of the diaphragm 9f may be composed of the non-magnet member 91f.

Next, an operation of the speaker device of this embodiment will be described. When an electrical signal is applied to the voice coil 11f in the drive portion 201f, a current flows through the voice coil 11f and a magnetic field is formed in the magnetic gap, so that a driving force is generated. The driving force vibrates the diaphragm 9f, thereby generating sound. The drive portion 201g also vibrates the diaphragm 9f in a manner similar to that of the drive portion 201f. Hereinafter, an operation of the drive portion 201f will be described.

The diaphragm 9f including the non-magnet member 91f vibrates in the gap between the first magnetic circuit 5f and the second magnetic circuit 6f. The vibration direction of the diaphragm 9f includes upward and downward directions (the y-axis direction). In this case, pulling forces in the vibration direction are alternately applied to the non-magnet member 91f by the magnetic field formed by the first and second magnetic circuits, depending on the vibration of the diaphragm 9f. In other words, in this embodiment, the non-magnet member 91f, the first magnetic circuit 5f, and the second magnetic circuit 6f play a role as a negative stiffness generating mechanism. In the drive portion 201g, the non-magnetic member 91g, and counterparts of the first and second magnetic circuits play a role as a negative stiffness generating mechanism. The negative stiffness generating mechanism is similar to that of the first embodiment above and will not be described. By the negative stiffness generating mechanism, the suppression by the acoustic stiffness of the empty room enclosed by the back surface frame 3f, the diaphragm 9f, and the edge 7f is relaxed, so that the drive portions 201f and 201g become easy to vibrate. Specifically, the diaphragm 9f operates as if the cabinet volume were large, so that the minimum resonant frequencies of the drive portions 201f and 201g are reduced. As a result, the limit of low-frequency sound reproduction can be expanded.

As described above, the negative stiffness generating mechanism relaxes the influence of the acoustic stiffness of the empty room enclosed by the back surface frame 3f, the diaphragm 9f, and the edge 7f. Thereby, the speaker device of this embodiment, even in the case of a small-size cabinet, operates as if the cabinet volume were large, so that the limit of low-frequency sound reproduction can be expanded.

Also, in this embodiment, the track-shaped diaphragm 9f is driven at two points by the drive portions 201f and 201g. Here, when a diaphragm has a shape in which not every point on the outer circumference thereof is equally distant from the center of gravity thereof (e.g., a track shape, an elliptical shape, etc.), divided resonance is likely to occur. Therefore, it is necessary to use a diaphragm having a cone shape or the like so as to increase the stiffness of the diaphragm. However, in the case of, for example, a thin speaker, since the depth of the cone shape cannot be increased, it is difficult to increase the stiffness. According to this embodiment, for example, by disposing the drive portions 201f and 201g for driving the diaphragm 9f at positions which correspond to nodes of the divided resonance, the divided resonance can be suppressed even when the stiffness of the diaphragm 9f is not high. Therefore, even in the case of a cone-shaped diaphragm, the divided resonance can be suppressed, thereby making it possible to achieve a thinner speaker.

Also, in this embodiment, the drive portion 201f and 201g each include one voice coil, and may include an additional voice coil. In this case, a magnetic plate and a magnet are added so that a magnetic gap is formed in the second magnetic circuit 6f and the second magnetic circuit of the drive portion 201g. Thereby, the driving forces of the drive portions 201f and 201g are increased, thereby making it possible to improve the output sound pressure level.

Although the diaphragm 9f is driven at two points by the drive portions 201f and 201g in this embodiment, a speaker unit(s) may be added so to provide three or more driving points. Also, the diaphragm 9f and the back surface frame 3f may be in the shape of a rectangle, an ellipse, or the like. Also, the yoke, the magnetic plate, the magnet, and the like are not limited to the cylindrical shape, and may have other appropriate shapes (e.g., a rectangular prism, etc.). Also, the first and second magnetic circuits of this embodiment may have the configuration of any of the magnetic circuits of the first to third embodiments.

### Fifth Embodiment

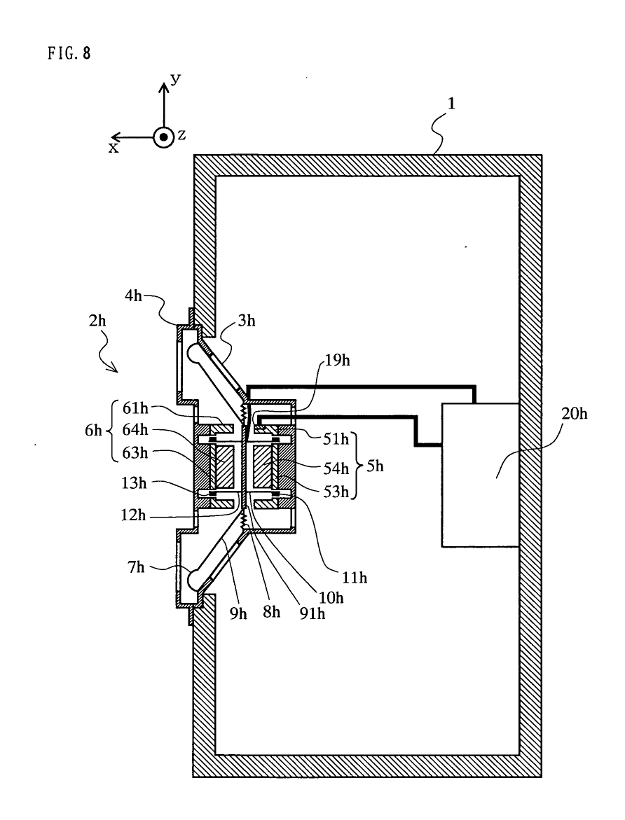

A speaker device according to a fifth embodiment of the present invention will be described with reference to FIG. 8. FIG. 8 is a cross-sectional view of a structure of the speaker device of the fifth embodiment. In FIG. 8, the speaker device of the fifth embodiment roughly comprises a cabinet 1, a speaker unit 2h, and a control circuit 20h. This embodiment is different from the above-described first to fourth embodiments in that a laser displacement gauge and a control circuit are additionally provided.

The speaker unit 2h is attached to an opening portion formed in the front surface of the cabinet 1. The speaker unit 2h has a back surface frame 3h, a front surface frame 4h, a first magnetic circuit 5h, a second magnetic circuit 6h, an edge 7h, a damper 8h, a diaphragm 9h, a first voice coil bobbin 10h, a first voice coil 11h, a second voice coil bobbin 12h, a second voice coil 13h, and a laser displacement gauge 19h.

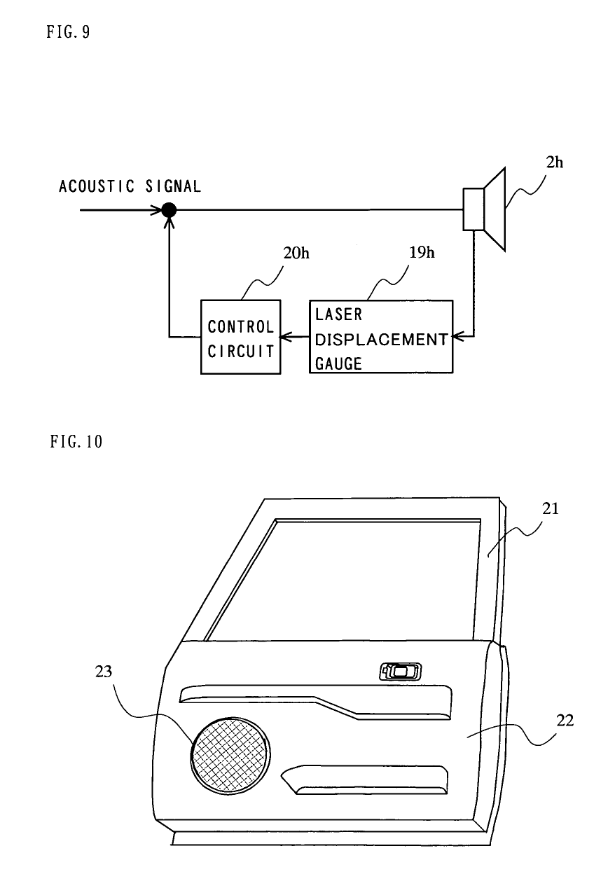

The speaker unit 2h has a structure different from that of the speaker unit 2d of FIG. 4 only in shapes of the back surface frame 3h, the front surface frame 4h, a yoke 51h, a yoke 61h, and will not be described in detail. Also, the speaker unit 2h is different from the speaker unit 2d in that the laser displacement gauge 19h is disposed in the speaker unit 2h. Hereinafter, these differences will be mainly described with reference to FIGS. 8 and 9. Note that FIG. 9 is a circuit block diagram of the speaker device of the fifth embodiment.

In FIG. 9, the laser displacement gauge 19h detects a displacement of the diaphragm 9h, and outputs the detection signal to the control circuit 20h. Also, in FIG. 8, the laser displacement gauge 19h is disposed at the yoke 51h and is connected to the control circuit 20h via a conductor. Note that the position of the laser displacement gauge 19h is not limited to the yoke 51h, and the laser displacement gauge 19h may be disposed at a position, such as the front surface frame 4h, the cabinet 1, or the like, which allows it to detect the displacement of the diaphragm 9h. Although a laser displacement gauge is used to detect the displacement of the diaphragm 9h, a small-size magnet may be fixed to the diaphragm 9h and a Hall element may be used to detect a position of the diaphragm 9h.

In FIG. 9, the control circuit 20h generates a control signal which causes a center of an amplitude of a non-magnet member 91h to be at a balanced position in a gap between the first and second magnetic circuits, based on the displacement of the diaphragm 9h detected by the laser displacement gauge 19h. The control signal generated in the control circuit 20h is added to an input acoustic signal. The input acoustic signal and the control signal are amplified as appropriate by an amplifier or the like before being applied to the speaker unit 2h. Note that the control signal is, for example, a direct current electrical signal which corrects a deviation of the non-magnet member 91h from the balanced position. Also, in FIG. 8, the control circuit 20h is provided inside the cabinet, and is connected via conductors to an input terminal and the laser displacement gauge 19h of the speaker unit 2h. Note that the control circuit 20h may be disposed outside the cabinet.

In the speaker unit 2h, the principle of driving the diaphragm 9h and the principle of generating a negative stiffness are similar to those of the above-described speaker unit 2d. By the negative stiffness generating mechanism, a repelling force is applied to the non-magnet member 91h in a direction which causes the non-magnet member 91h to go away from the balanced position. Here, the case where temperature is increased inside the cabinet 1. The first voice coil 11h and the second voice coil 13h generate heat when a current flows therethrough. When the temperature inside the cabinet 1 is increased due to heat generation of the first and second voice coils, the air inside the cabinet 1 is expanded or contracted, so that the inside pressure is changed. Due to the pressure change, a force is applied to the diaphragm 9h, so that the center of the amplitude of the non-magnet member 91h is deviated from the balanced position. The repelling force is symmetric about the balanced position as a reference in the vibration direction. Therefore, when the center of the amplitude of the non-magnet member 91h is deviated from the balanced position, the symmetry of the repelling force is extremely disrupted, so that a large distortion occurs in reproduced sound. When the deviation from the balanced position becomes large, the diaphragm 9h remains pulled by the first magnetic circuit 5h or the second magnetic circuit 6h and cannot vibrate. However, in this embodiment, the control circuit 20h generates a control signal which causes the center of the amplitude of the non-magnet member 91h to be at the balanced position, and adds the control signal to the input acoustic signal. Thereby, the diaphragm 9h can be stably operated with the center of the amplitude of the non-magnet member 91h being at the balanced position, irrespective of a change in surrounding environments, such as a change in temperature or the like. Therefore, sound can be reproduced with a less distortion. Although the speaker unit 2h is used in the speaker device of this embodiment, the speaker units of the first to fourth embodiments may be used.

Note that the speaker devices of the first to fifth embodiments are disposed inside the body of a car, as an example. For example, the speaker device is provided in a door of the car. FIG. 10 is a diagram illustrating an example in which a speaker unit is provided in a car door.

In FIG. 10, the car door is composed of a window portion 21, a door main body 22, and a speaker unit 23. Here, the speaker unit 23 is, for example, the speaker unit of any of the above-described first to fifth embodiments, and will not be described. The speaker unit 23 is attached inside the door main body 22. A space is formed inside the door main body 22. In other words, the door main body 22 serves as a cabinet for the speaker unit 23. Therefore, the speaker unit 23 and the main body 22 constitute a speaker device. Thus, by applying the speaker unit 23 to a car door, it is possible to provide an in-car listening environment in which a low-frequency sound reproduction band is expanded even when the door main body 22 is a conventional one.

Also, a window glass storing portion, an automatic window opening/closing mechanism, a door lock, wires, a control circuit, and the like are provided inside the door main body 22, the internal volume of the door main body 22 is limited. Even in the case of car doors, in which the internal volume is limited, it is possible to reproduce a lower frequency band as compared to when conventional speaker units are employed.

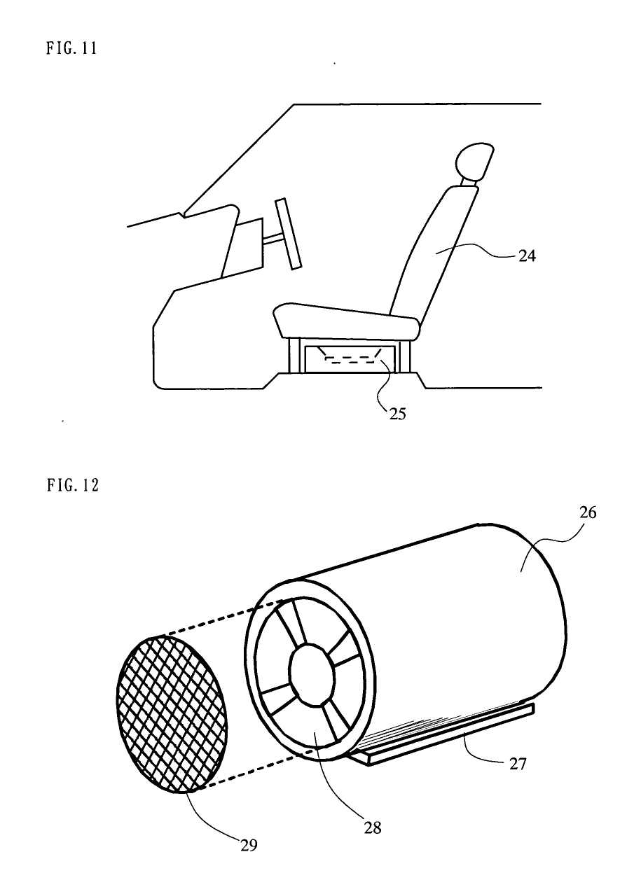

The speaker devices of the first to fifth embodiments may be disposed inside the body of a car, for example. FIG. 11 is a diagram illustrating an exemplary speaker device which is disposed inside a car. In FIG. 11, for example, a speaker device 25 is provided under a seat 24. Here, the speaker device 25 is any of the speaker devices of the first to fifth embodiments, and will not be described in detail. Thus, by providing the speaker device 25 into a car, it is possible to provide an in-car listening environment in which a low-frequency sound reproduction band is expanded even when the cabinet volume is the same as the conventional one.

Also, when it is aimed to achieve low-frequency sound reproduction to the same level as that of the conventional art, the cabinet of the speaker device 25 can be further reduced as compared to the conventional art. By providing the speaker device 25 in a car, a larger space can be secured in the car. The present invention is particularly effective for low-frequency sound speaker devices, such as a subwoofer and the like, which generally require a large volume cabinet.

Also, the speaker devices of the first of seventh embodiments may be an in-car speaker device illustrated in FIG. 12. FIG. 12 is a diagram illustrating another exemplary speaker device which is provided inside a car. In FIG. 12, the speaker device comprises a cabinet 26, a pedestal 27, a speaker unit 28, and a punching net 29. Here, the speaker unit 28 is any of the speaker units of the above-described first to fifth embodiments, and will not be described in detail. Thus, by providing the speaker device of FIG. 12 inside a car, it is possible to provide an in-car listening environment in which a low-frequency sound reproduction band is expanded even when the cabinet volume is the same as the conventional one.

Also, when it is aimed to achieve low-frequency sound reproduction to the same level as that of the conventional art, the cabinet of the speaker device can be further reduced as compared to the conventional art. Therefore, by providing the speaker device in a car, a larger space can be secured in the car. The present invention is particularly effective for low-frequency sound speaker devices, such as a subwoofer and the like, which generally require a large volume cabinet. Note that the shape of the cabinet 26 is not limited to the cylindrical shape of FIG. 12, and may be a cuboidal shape or the like.

Also, the speaker devices of the first to fifth embodiments are provided in, for example, AV systems and the like. As an example, the speaker devices of the first to fifth embodiments are provided in video devices (e.g., cathode-ray tube televisions, liquid crystal televisions, plasma televisions, etc.).

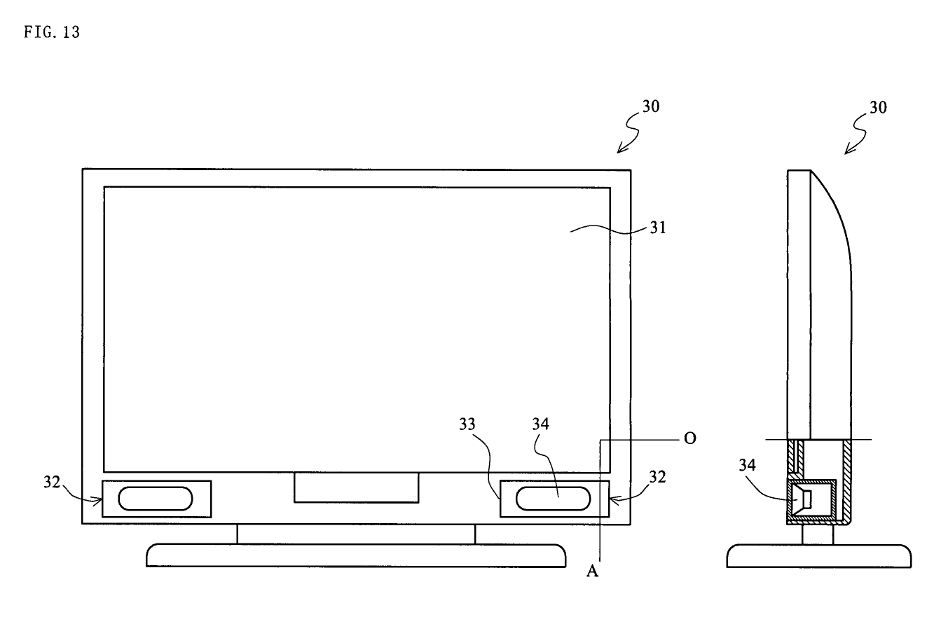

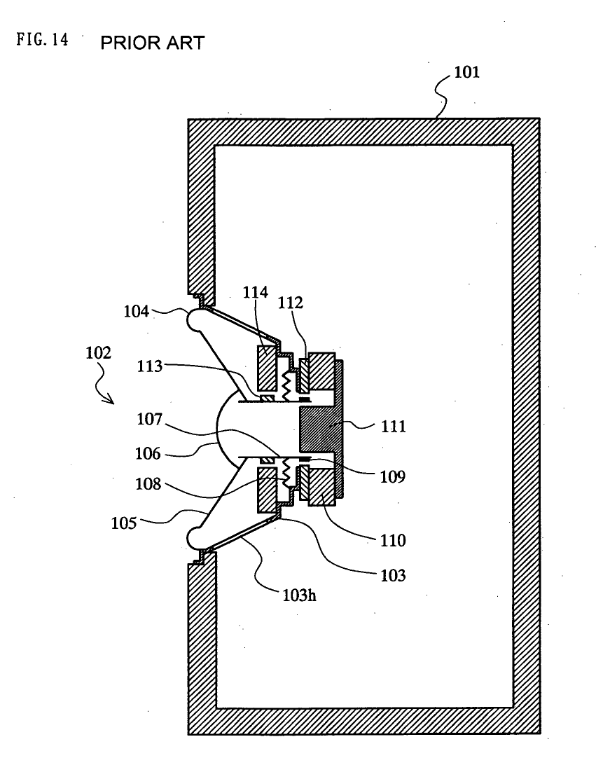

FIG. 13 is a diagram illustrating an exemplary configuration in which the above-described speaker device is provided in a thin television. FIG. 13 illustrates a front view of the thin television, and a cross-sectional, side view, partially taken along line O-A. In FIG. 13, the thin television comprises a thin television main body 30, a display 31, and two speaker devices 32. The speaker device 32 is any of the speaker devices of the first to fifth embodiments and will not be described in detail.

A cabinet 33 of the speaker device 32 is disposed inside a housing provided below the display 31. A speaker unit 34 is, for example, an elliptical speaker unit, which is attached to the cabinet 33. Thus, by providing the speaker device of the present invention to the thin television main body 30, it is possible to provide a listening environment in which a low-frequency sound reproduction band is expanded even when the cabinet volume is the same as the conventional one.

Also, in the thin television main body 30, when it is aimed to achieve low-frequency sound reproduction to the same level as that of the conventional art, the cabinet 33 of the speaker device 32 can be further reduced as compared to the conventional art. Therefore, in the case where a smaller space for a speaker device is required when the thin television main body 30 is further thinned or miniaturized, by providing the speaker device 32, the thin television main body 30 can be thinned or miniaturized. Although the cabinet 33 of the speaker device 32 of FIG. 13 is attached below the display 31, the cabinet 33 may be disposed on both sides of the display 31.

### INDUSTRIAL APPLICABILITY

The speaker device of the present invention can reproduce a low-frequency sound band even when the cabinet volume is small, and can be applied to applications, such as speaker devices for liquid crystal televisions or PDPs (plasma displays), audio devices, and 5.1-channel reproduction home theaters, in-car speakers, and the like.

1-17. (canceled)

18. A speaker device comprising:
a housing having an opening portion;
a vibration system member for vibrating to generate sound;
a support system member connected to the housing and for supporting the vibration system member in a manner which allows the vibration system member to vibrate;
a first magnetic circuit disposed inside the housing and having a first magnet provided on a surface thereof facing the opening portion, and a first yoke provided lateral to the first magnet; and
a second magnetic circuit having a second magnet disposed facing the first magnet via a gap, and a second yoke provided lateral to the second magnet,
wherein a magnetic gap is formed in at least one of an interval between a side surface of the first magnet and the first yoke in the first magnetic circuit and an interval between a side surface of the second magnet and the second yoke in the second magnetic circuit,
the vibration system member includes:
a first voice coil;
a first voice coil bobbin provided to dispose the first voice coil in the magnetic gap; and
a magnetic member made of a magnetic material other than a magnet, and connected directly or indirectly to the first voice coil bobbin so that the magnetic member is disposed in the gap between the first magnet and the second magnet.

19. The speaker device according to claim 18, wherein
the vibration system member further includes a diaphragm at least a portion of which is composed of the magnetic member,
the first voice coil bobbin is fixed to the diaphragm, and
the support system member supports the diaphragm in the gap in a manner which allows the diaphragm to vibrate.

20. The speaker device according to claim 18, wherein
the second magnetic circuit further includes:
a magnetic plate fixed to a surface facing the opening portion of the second magnet,
the second yoke is disposed lateral to the second magnet and the magnetic plate, and forms a magnetic gap between the second magnet and a side surface of the magnetic plate,
the vibration system member further includes a diaphragm disposed, facing a surface facing the opening portion of the housing of the second magnetic circuit,
the first voice coil bobbin connects the diaphragm and the magnetic member via the magnetic gap formed in the second magnetic circuit, and
the first voice coil is disposed in a magnetic gap formed in the second magnetic circuit.

21. The speaker device according to claim 20, wherein
the first magnetic circuit further includes a magnetic plate fixed to a surface facing inside of the housing of the first magnet,
the first yoke is disposed lateral to the first magnet and the magnetic plate, and forms a magnetic gap between the first magnet and a side surface of the magnet plate, and
the vibration system member further includes:
a second voice coil; and
a second voice coil bobbin fixed to the magnetic member and for disposing the second voice coil in the magnetic gap formed in the first magnetic circuit.

22. The speaker device according to claim 18, wherein
the second magnetic circuit further includes:
a magnetic plate fixed to a surface facing the opening portion of the second magnet,
the second yoke is disposed lateral to the second magnet and the magnetic plate, and forms a magnetic gap between the second magnet and a side surface of the magnetic plate,
the vibration system member further includes:
a diaphragm disposed, facing a surface facing the opening portion of the housing of the second magnetic circuit; and
a connection member for connecting the diaphragm and the magnetic member via the magnetic gap formed in the second magnetic circuit, and
the first voice coil bobbin disposes the first voice coil in the magnetic gap formed in the first magnetic circuit.

23. The speaker device according to claim 18, wherein
the first and second magnetic circuits have the same structure, and
the second magnetic circuit and the first magnetic circuit are arranged symmetrically about the magnetic member.

24. The speaker device according to claim 23, wherein
the vibration system member further includes:
a second voice coil; and
a second voice coil bobbin connected directly or indirectly to the magnetic member and for disposing the second voice coil in the magnetic gap formed in the first magnetic circuit,
the first voice coil bobbin disposes the first voice coil in the magnetic gap formed in the second magnetic circuit.

25. The speaker device according to claim 18, wherein
the first magnetic circuit further includes:
a magnetic plate fixed to a surface facing inside of the housing of the first magnet; and
a third magnet fixed to a surface facing inside of the housing of the magnetic plate, and
the first yoke is provided to form a magnetic gap between the first yoke and a side surface of the magnetic plate, and
the first magnet and the third magnet are magnetized in directions opposite to each other, the directions being vibration directions of the vibration system member.

26. The speaker device according to claim 18, wherein
the second magnetic circuit further includes:
a magnetic plate fixed to a surface facing the opening portion of the housing of the second magnet; and
a third magnet fixed to a surface facing the opening portion of the housing of the magnetic plate, and
the second yoke is provided to form a magnetic gap between the second yoke and a side surface of the magnetic plate, and
the second magnet and the third magnet are magnetized in directions opposite to each other, the directions being vibration directions of the vibration system member.

27. The speaker device according to claim 18, wherein
the first magnetic circuit further includes:
a magnetic plate fixed to a surface facing inside of the housing of the first magnet,
the first yoke is provided to form a magnetic gap between the first yoke and a side surface of the magnetic plate, and
the first magnet is magnetized in a vibration direction of the vibration system member.

28. The speaker device according to claim 18, wherein
the second magnetic circuit includes:
a magnetic plate fixed to a surface facing the opening portion of the second magnet,
the second yoke is provided to form a magnetic gap between the second yoke and a side surface of the magnetic plate, and
the second magnet is magnetized in a vibration direction of the vibration system member.

29. The speaker device according to claim 18, where
the speaker device comprises a plurality of magnetic circuit units each composed of the first and second magnetic circuits,
the vibration system member includes:
the same number of the first voice coils as the number of the magnetic circuit units;
the same number of the first voice coil bobbins as the number of the magnetic circuit units, each first voice coil being disposed in the magnetic gap of the corresponding magnetic circuit unit; and
a diaphragm fixed to each first voice coil bobbin and at least a portion of which is composed of a the magnetic magnet member.

30. The speaker device according to claim 18, further comprising:
a position detecting section for detecting a position of the vibration system member; and
a control section for controlling a vibration of the vibration system member by applying to the first voice coil a signal obtained by adding a direct current component to an acoustic signal based on the position of the vibration system member detected by the position detecting section so that a center of an amplitude of the magnetic member is at a balanced position of a magnetic field formed in the gap.

31. The speaker device according to claim 30, wherein the position detecting section is a laser displacement gauge.

32. The speaker device according to claim 18, further comprising:
a frame fixed to the support system member,
wherein a speaker unit composed of the vibration system member, the support system member, the first and second magnetic circuits, and the frame, is attached to the opening portion by the frame being fixed to the opening portion.

33. A car comprising:
the speaker device according to claim 18; and
a car body inside which the speaker device is disposed.

34. A video device comprising:
the speaker device according to claim 18; and
a device housing inside which the speaker device is disposed.
